(19) United States
(12) Patent Application Publication
(10) Pub. No.: US 2008/0251610 A1
(43) Pub. Date: Oct. 16, 2008

(54) SPRAY HANDLE WITH DETACHABLE FRONT WAND ADAPTOR

(75) Inventor: Barry Franks, Derry, NH (US)

Correspondence Address: Vern Maine & Associates, 100 MAIN STREET, P O BOX 3445, NASHUA, NH, 03061-3445, US

(73) Assignee: UNIFIX USA LLC., Derry, NH (US)

(21) Appl. No.: 12/102,204

(22) Filed: Apr. 14, 2008

Related U.S. Application Data
(60) Provisional application No. 60/911,750, filed on Apr. 13, 2007.
(60) Provisional application No. 60/941,451, filed on Jun. 1, 2007.

(51) Int. Cl. B05B 7/04; B05B 15/06

(52) U.S. Cl. 239/433; 239/532

(57) ABSTRACT

A system is provided for the spraying of a fluid, that system having: a spray handle; a fluid channel disposed within the handle, through which the fluid is introduced into the handle; a trigger disposed within the handle; a stopper actuated by the trigger whereby flow of the fluid from the fluid channel is regulated; a wand removably coupled to a distal end of the fluid channel and through which the fluid exits the system.

### RELATED APPLICATIONS

This application claims the benefit of U.S. Provisional Applications No. 60/911,750, filed Apr. 13, 2007, and No. 60/941,451, filed Jun. 1, 2007. Each of these applications is herein incorporated in its entirety by reference.

### FIELD OF THE INVENTION

The invention relates to spray wands, and more particularly, to a spray handle with a detachable wand adaptor.

### BACKGROUND OF THE INVENTION

Spray guns are used in a variety of applications: painting, extermination, cleaning, etc. Known spray handles are susceptible to a variety of faults, including but not limited to clogging, frozen lines.

On occasion different spray wands are required during a application, likewise wands may become clogged and may require removal to facilitate cleaning. Current spray guns are equipped with wands that are difficult to replace, requiring the replacement of the entire spray handle, or the arduous disassembly thereof.

What is needed, therefore, are techniques for providing spray handles with readily removable wands with disassembly facilitating cleaning of valve parts.

### SUMMARY OF THE INVENTION

One embodiment of the present invention provides a system for the spraying of a fluid, the apparatus having: a spray handle; a fluid channel disposed within the handle, through which the fluid is introduced into the handle; a trigger disposed within the handle; a stopper actuated by the trigger whereby flow of the fluid from the fluid channel is regulated; a wand removably coupled to a distal end of the fluid channel and through which the fluid exits the system.

Another embodiment of the present invention provides such a system wherein the stopper comprises a sealing plunger assembly disposed within the spray handle and controlling emissions of the fluid from the distal end of the fluid channel.

A further embodiment of the present invention provides such a system wherein the plunger assembly includes an o-ring disposed at a distal end of the plunger such that the o-ring is compressed by the plunger against the interior of the distal end of the fluid channel

Yet another embodiment of the present invention provides such a system further comprising a detachable wand adaptor, configured to be affixed to a distal end of the spray handle and for receiving the wand.

A yet further embodiment of the present invention provides such a system wherein the detachable wand adaptor comprises the distal end of fluid channel such that its detachment exposes the stopper.

Even another embodiment of the present invention provides such a system further comprising a filter disposed between the stopper and the distal end of the fluid channel.

An even further embodiment of the present invention provides such a system wherein the filter comprises a perforated filter.

Still another embodiment of the present invention provides such a system wherein the filter comprises a frit.

A still further embodiment of the present invention provides such a system further comprising a second fluid channel.

Still yet another embodiment of the present invention provides such a system wherein the second fluid control channel is uncontrolled by the stopper.

A still yet further embodiment of the present invention provides such a system wherein the second fluid is different from the first fluid.

Still even another embodiment of the present invention provides such a system wherein the second fluid is a gas.

A still even further embodiment of the present invention provides such a system wherein the fluid is a liquid.

One embodiment of the present invention provides a system for the spraying of fluid, the system having: a spray handle; a removable wand attachment nozzle; a fluid valve accessible by removal of the wand attachment nozzle.

Another embodiment of the present invention provides such a system further comprising an o-ring seal disposed within the fluid valve.

A further embodiment of the present invention provides such a system wherein the o-ring is comprised of polytetrafluoroethylene.

Yet another embodiment of the present invention provides such a system further comprising a wand disposed in the wand attachment nozzle, the wand comprising a elongate tubular member, and a flexible tube disposed with the tubular member.

A yet further embodiment of the present invention provides such a system wherein the tube comprises polyurethane tubing.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a plan view of the left side and hose attachment end of a spray handle configured in accordance with one embodiment of the present invention.

FIG. 2A is a front elevation view of a spray nozzle configured according to one embodiment of the present invention.

FIG. 2B is a cross sectional elevation view of a spray nozzle configured according to one embodiment of the present invention.

FIG. 3 is a plan view of the right side of a spray handle depicting the separated detachable wand adapter configured in accordance with one embodiment of the present invention.

FIG. 4 is a perspective view of a spray handle depicting the separated detachable wand adapter configured in accordance with one embodiment of the present invention.

FIG. 5 is a side elevation view of a spray nozzle configured according to one embodiment of the present invention.

FIG. 6 is a section view from the right side and a view of the hose attachment end of a spray handle configured in accordance with one embodiment of the present invention.

FIG. 7 is an expanded side elevation view of a spray nozzle configured according to one embodiment of the present invention.

FIG. 8 is a perspective view of a spray nozzle configured according to one embodiment of the present invention.

FIG. 9 is a perspective view of a spray nozzle configured in accord with one embodiment of the present invention further comprising a line control valve.

### DETAILED DESCRIPTION

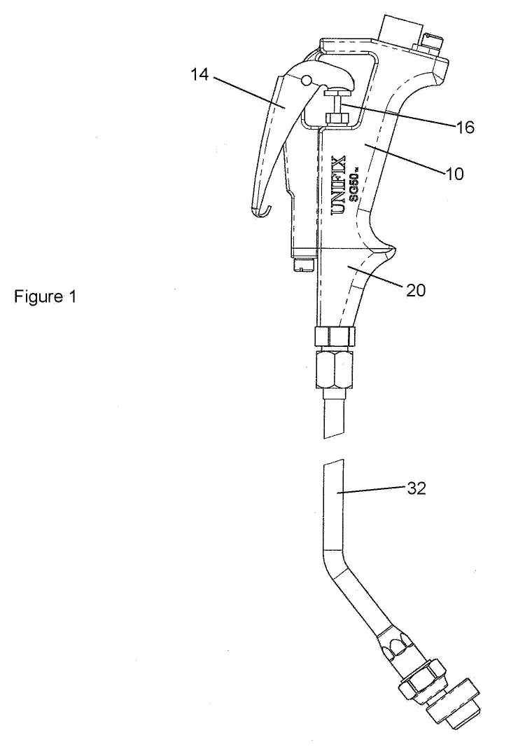

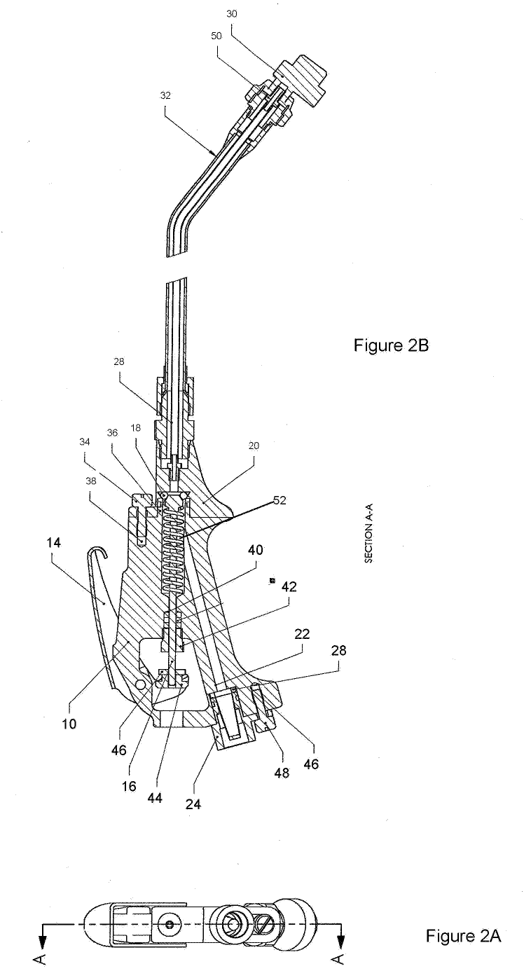

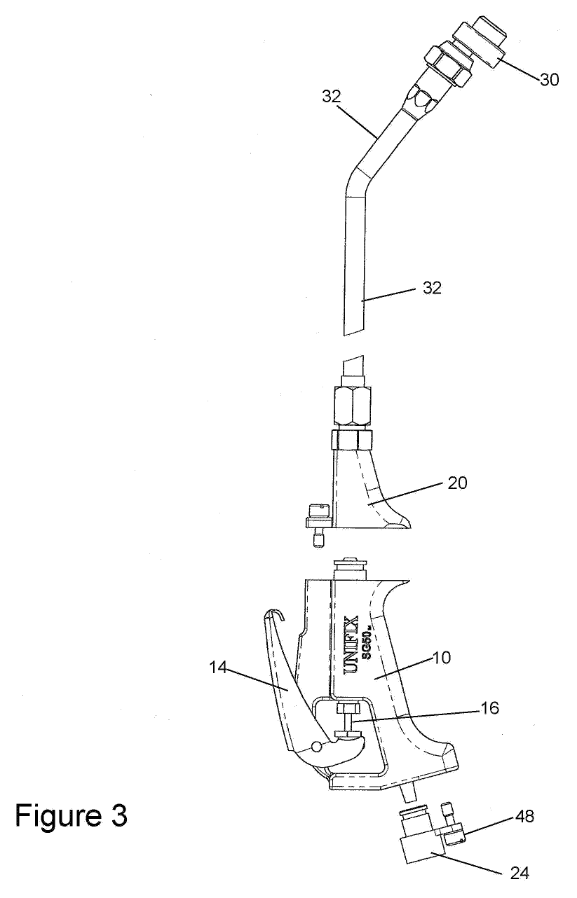

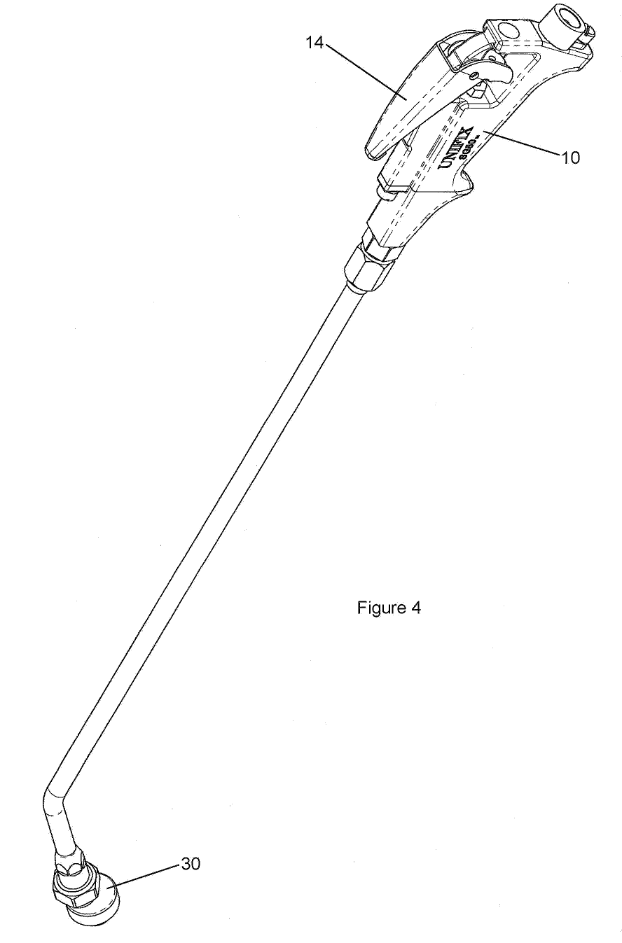

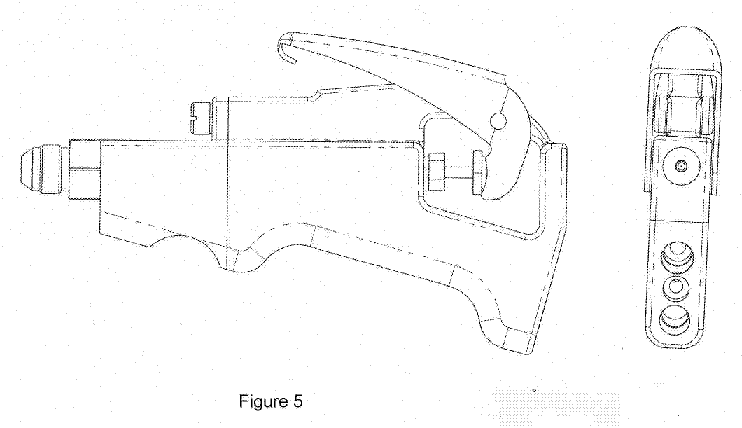

According to one embodiment of the present invention illustrated in FIGS. 1-4, the handle 10 combines a single port 12 which allows chemical entry and exit of liquids. The body 10 is conformed into a simple gun spraying device controlled by a hand operated handle 14 which controls the plunger 16 which seals itself into the O-Ring 18 housed in the detachable wand adapter body 20. The plunger 16 controls the flow of fluid through the liquid inlet channel 22. The detachable wand adapter body 20 allows simple changing of wand types and sizes. The Detachable Front Wand Adapter 20 allows the user to simply remove the Detachable Front Wand Adapter 20 and change wands. One embodiment of the invention provides a handle 10 that will include a filter port 24 which will be accessible by a thumb screw with no tools needed to clean and service the filter 26. Thumb screw 48 is, in one embodiment, provided to secure a filter housing 46 and the filer 26. The chemical line can be connected from the detachable nose 20 to the spray tip 30 via polyurethane or other suitable tube 28. The chemical will run inside of the rubber tube 28 instead of freely running through the metal wand 32 allowing expansion, thereby preventing cracking of the wand 32 in cold weather. In one embodiment, wand 32 is coupled to the tip 30 by means of a clip or coupling 50.

As noted above, a Spray Handle Body 10 is provided with a Detachable front wand adapter (Detachable Front Wand Adapter) 20. Disposed within the handle is a plunger 16 which extends from the handle body to the Detachable Front Wand Adapter. The plunger 16 is secured to the trigger 14 of the handle body 10 by lock nuts 44 and 46. The distal end of the plunger 16 is configured to stop the liquid inlet channel 22 by means of a o-ring seal or other suitable compliant seal 18.

In one embodiment of the present invention a straight through drill port allowing proper connection of a female port which inverts into the (Detachable Front Wand Adapter) this port also has an indentation for flat perforated filter screen which seats in the indentation at the bottom of the port. The filter is locked in by an O-Ring 18 (#202) which also seats into the bottom of the port.

A thumb screw or other suitable retaining means 34, such as a clip, wing nut, bolt or latch may be used to connect the spray body 10 to Detachable Front Wand Adapter 20 may be used in conjunction with a retention means receiving port 38. This connection between the adaptor 20 and the body 10 is made by mating a male coupler 36 extending from spray body 10 to connect to a corresponding female receiving port disposed in the detachable front wand adaptor 20. The male coupler 34 may, in one embodiment be equipped with as #14 O-ring for sealing the liquid inlet channel 22. Additional means from minimizing leakage and contamination of the liquid passing through the handle 10 including a Teflon housing indentation 40 configured to receive Teflon seal 42 and a Teflon packing screw 42.

In one embodiment, the handle consists of a plunger rod 16 which is pushed forward into the #202 O-ring 18 by a spring 52 which is housed inside of the spray handle body 10. The plunger 16 continues through the entire spray body and communicating with the handle 14. In such an embodiment, the plunger passes through washers and nuts 40, 42. The handle 10 attaches on plunger between locking nuts 44, 46. When the handle trigger 14 is in a resting position the plunger 16 will seal into the O-ring in port 18. When the handle 10 is manually squeezed the plunger 16 will pull back and the intended substance will be pass through filter port 24. From the filter port 24, the fluid passes through the inlet channel 22, through the plunger spring 52, and past the plunger 16 and the o-ring 18. Once the solution continues through port sealed by o-ring 18, it is free to exit the handle 10 and nose 20 via the connected tube 28 and discharges through the spray tip 30.

Another embodiment of the present invention provides dual port spray handle which combines two ports which allow dual entry and exit of separate liquids, air, or a combination of materials. The body is conformed into a simple gun spraying device controlled by a hand operated handle which controls the plunger which seals itself into an o-ring housed in the detachable wand adaptor body. The detachable wand adaptor body allows simple changing of wand types and sizes. The majority of atomizers require separation of substances until point of entry. This can be difficult when there are two lines or ports in a wand. The detachable front wand adaptor detachable front wand adaptor.) allows technicians to remove the detachable front wand adaptor and change wands simply.

A handle configured according to one embodiment of the present invention is advantageous in atomizing procedures. For example, this handle can serve as a controlling device for mixing air and liquid pesticides to create an atomized fog. A use of this handle is as a controllable device for atomizing substances such pesticides and insecticides as well as soap and other chemical agents which need to be transformed from a simple liquid or a gaseous state to an atomized state that may activate a controlled ingredient to affect the insects, pests, mold, fungicides etc.

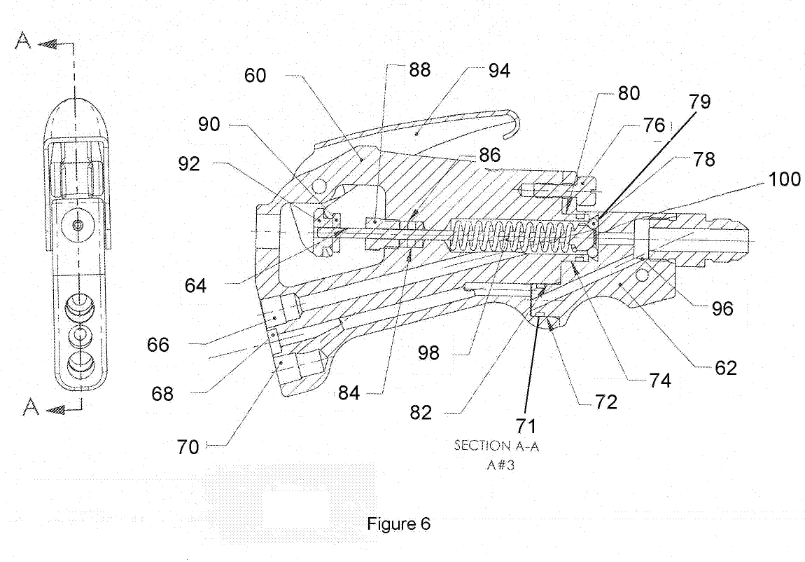

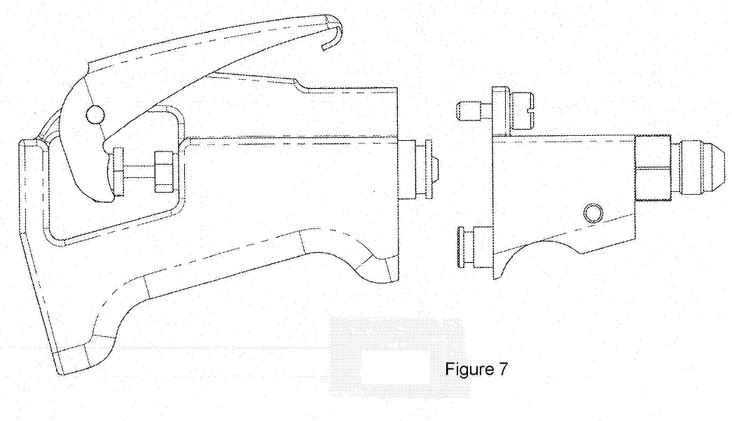

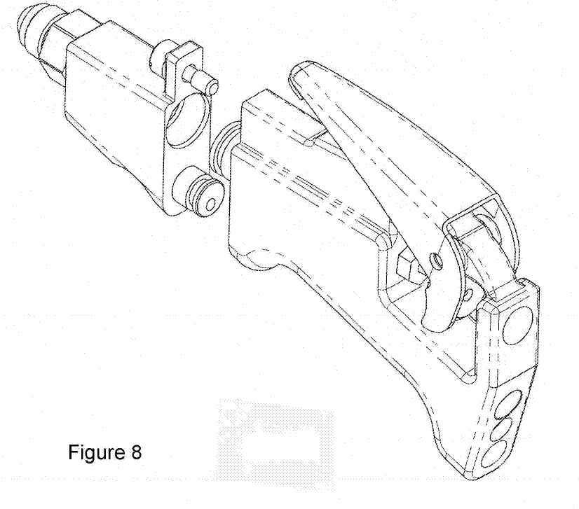

The process of operation of one embodiment of the present invention is described by referring to FIG. 6. A spray handle body 60 is provided with a detachable front wand adaptor 62. A plunger 64 extends from the handle body to the detachable front wand adaptor 62. A controlled inlet 64 for a controlled fluid such as air, compressed gas, liquid, or chemical agents, is provided, and controlled by the plunger 64 and seal (o-ring) 78. A straight through drill port 68 allowing proper connection of an uncontrolled inlet 70 for uncontrolled variable substance. A male port 72 extends from the detachable front wand adaptor 62 and may be sealed with a o-ring, in one embodiment a size #11 o-ring, or other suitable seal 71. The port 72 is allows for continuous flow of whichever substance is utilizing the port 72, as the fluid bypasses the valve controlled by the plunger 64. A female port 74 is provided in the detachable front wand adaptor 62 to receive a male mating member 80 of the spray handle 60. This female port 74 may also have an indentation 79 for a flat perforated filter screen or frit 100 disposed at the bottom of the port 74. The filter is locked in by an o-ring 78, such as #202, which also seats into the bottom of the port 74. A thumb screw 76 connects the spray body 60 to detachable front wand adaptor 62. An o-ring 78 which seats in the female part 74, is secured by the male port 80 extending from spray body 60 to connect to the female port 74. This o-ring 78 is compressed by the plunger 64 when the trigger is not engaged, closing the fluid channel 66. A second female port housing 82 is disposed in the in spray handle 60 for connection of a packing screw 88. A housing indentation 84 is provided in one embodiment manufactured from polytetrafluoroethylene (PTFE) such as that sold under the trademark Teflon® in which are disposed seals 86, also manufactured from, in on embodiment polytetrafluoroethylene. No claim is made to the trademark Teflon®. A first and second lock nuts 90, 92 are provided to couple the plunger to the trigger 94. In such a duel port design, mixing of the controlled and uncontrolled fluids occurs in the nozzle chamber 96, immediately prior to the passage of the mixture of the two fluids into the wand.

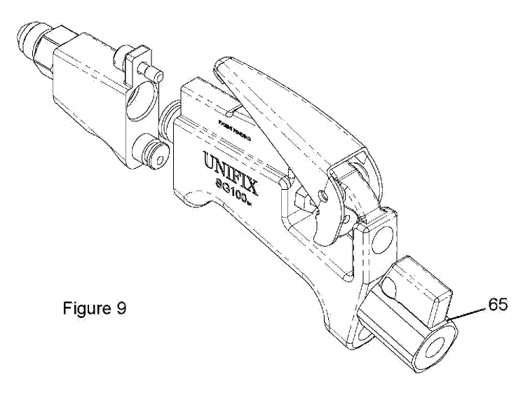

As illustrated in FIG. 9, in one embodiment of the present invention, the controlled inlet 64 is controlled by a line control valve 65 disposed at the proximal end of the inlet 64. In one embodiment, this line control valve 65 is a ball valve. This ball valve 65 regulates flow into the inlet 64, and when the inlet 64 is detached from the ball valve 65, stops the flow of fluid, preventing or minimizing emission or spillage of potentially hazardous chemical agents. One skilled in the art will appreciated that other valve types may be used where pressure a pressure imbalance between sides of the valve causes the valve to close.

The handle 94 comprises a plunger rod 64 which is pushed forward into an o-ring 78 such as a #202 o-ring, by a spring 98 which is housed inside of the spray handle body 60. The plunger 64 continues through the entire spray body exiting through a series of seals 86,84 and a packing screw 88. The handle attaches on plunger between first and second locking nuts 90, 92. When the handle 94 is in a resting position, the plunger 64 will seal into the o-ring 78 disposed within the female port 74 of the removable wand adaptor 62. When the handle 94 is squeezed, the plunger 64 will pull back and the intended substance will be pass through Port 74 into the wand (not shown). Once the solution continues through port 74, it may mix with the other solution in the uncontrolled port 68 in port chamber 96. In alternative embodiments, the fluid of port 74 can continue down into the wand assembly and atomize at a further point within the wand.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An system for the spraying of a fluid, said apparatus comprising:
a spray handle;
a fluid channel disposed within said handle, through which said fluid is introduced into said handle;
a trigger disposed within said handle;
a stopper actuated by said trigger whereby flow of said fluid from said fluid channel is regulated;
a wand removably coupled to a distal end of said fluid channel and through which said fluid exits said apparatus.

2. The system of claim 1 wherein said stopper comprises a sealing plunger assembly disposed within said spray handle and controlling emissions of said fluid from said distal end of said fluid channel.

3. The system of claim 2 wherein said plunger assembly includes an o-ring disposed at a distal end of said plunger such that said o-ring is compressed by said plunger against the interior of said distal end of said fluid channel.

4. The system according to claim 1 further comprising a detachable wand adaptor, configured to be affixed to a distal end of said spray handle and for receiving said wand.

5. The system according to claim 4 wherein said detachable wand adaptor comprises the distal end of fluid channel such that its detachment exposes said stopper.

6. The system according to claim 1 further comprising a filter disposed between said stopper and said distal end of said fluid channel.

7. The system according to claim 6 wherein said filter comprises a perforated filter.

8. The system according to claim 6 wherein said filter comprises a frit.

9. The system according to claim 1 further comprising a second fluid channel.

10. The system according to claim 9 wherein said second fluid control channel is uncontrolled by said stopper.

11. The system according to claim 10 wherein said second fluid is different from said first fluid.

12. The system according to claim 10 wherein said second fluid is a gas.

13. The system according to claim wherein said fluid is a liquid.

14. A system for the spraying of fluid, the system comprising:
a spray handle;
a removable wand attachment nozzle;
a fluid valve accessible by removal of the wand attachment nozzle.

15. The system according to claim 14, further comprising an o-ring seal disposed within said fluid valve.

16. The system according to claim 15 wherein said o-ring is comprised of polytetrafluoroethylene.

17. the system according to claim 14 further comprising a wand disposed in said wand attachment nozzle, said wand comprising a elongate tubular member, and a flexible tube disposed with said tubular member.

18. The system according to claim 17 wherein said tube comprises polyurethane tubing.

19. The system according to claim 14 further comprising a valve disposed between a fluid supply line and an inlet to said spray handle such that said valve is closed when said fluid supply line is disconnected from said inlet.

20. The system according to claim 19 wherein said valve is a ball valve.
